(19) United States
(12) Patent Application Publication
(10) Pub. No.: US 2006/0102375 A1
(43) Pub. Date: May 18, 2006

(54) Stepped compression connector

(75) Inventor: Carl R. Tamm, Trussville, AL (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Hubbell Incorporated

(21) Appl. No.: 10/988,838

(22) Filed: Nov. 16, 2004

(51) Int. Cl. H01R 4/18

(52) U.S. Cl. 174/84 C

(57) ABSTRACT

A stepped compression connector includes a body having an exterior surface, a cable receiving open end, and a terminal connection end with an end wall. A generally tubular bore extends into the body from the open end and includes an inner surface. An axial slot is disposed on the inner surface for facilitating compression of the body. Two surface contours are positioned on the inner surface having different diameters forming at least one step there between.

### CROSS REFERENCE

This application is related to U.S. patent application Ser. No. ______, filed concurrently herewith and entitled “Compression Connector Assembly,” of Carl R. Tamm, the subject matter of which is hereby incorporated by reference.

### FIELD OF THE INVENTION

The present invention relates to a stepped compression connector which reduces the detrimental effects of aluminum oxidation on electrical connections. The compression connector is stepped and includes a substantially tubular bore providing an electrically clean and intimate current path from all strands of a cable to the compression connector.

### BACKGROUND OF THE INVENTION

A compression connector typically includes a hollow tubular section which is deformed with a special tool. The tool compresses or crimps the body of an electrical connector onto a conductor cable.

Compression connectors, by virtue of their design, only make contact with the outermost periphery of the conductor. The vast majority of conductors in use today, particularly in the utility industry, are composed of a plurality of individual strands, formed into a multiple stranded cable. Some of these cables have a steel core overlaid by one or more layers of conductive aluminum stranding with individual strands. The individual strands are laid in each layer in an opposite direction to an adjacent layer, thereby making each adjacent layer distinctive from one another.

The advent of increasing power demands results in electrical connectors being operated at much higher current levels. Consequently, higher current levels result in much higher temperatures. The increased load on the electrical grid amplifies the current density and thermal stress of the entire system. Therefore, compression connectors, are weak links in the system, and are failing at an increasing rate.

The majority of failures occur in aluminum compression connectors and conductors. The reasons for these failures are two-fold. First, the vast majority of new connectors and conductors being installed are aluminum. Second, high integrity aluminum connections are difficult to achieve due to oxidation. Aluminum oxide is a highly effective electrical insulator, and aluminum oxide is detrimental to the integrity of a compression connector on an aluminum conductor.

Aluminum has a very high chemical affinity with oxygen, causing aluminum oxide to be formed easily. By simply exposing aluminum to air, a very thin oxide film will form on the aluminum surface. As a result, oxide layers forming on both the cable and connector are a reason for concern. Conductivity of the electrical interface between the connector and the conductor is severely reduced when oxides are present.

Aluminum oxide is a highly effective electrical insulator and is an adversarial component which needs addressing to ensure the integrity of a compression connection on an aluminum conductor. The surfaces of the conductor stranding are continuously exposed to oxygen. Consequently, an oxide coating forms on the conductor stranding. Typical compression connectors only make contact with the outermost periphery of the conductors stranding and cannot physically access the inner layers. The oxide coating on the inner layers must be penetrated during the installation process to form a high integrity electrical connection.

Presently, the most effective method of cleaning the conductor is to unlay the strands of the outer layers. The inner layers are exposed and are cleaned by vigorous brushing. Consequently, the formation of tenacious, highly resistive aluminum oxide is reduced.

The problem with this cleaning method is that it is highly time consuming and very difficult to accomplish in the field. The process of unlaying the stranding of the conductor a sufficient distance from the end to allow cleaning of individual stranding is laborious and tedious. While this method is possible in a typical laboratory condition, where the conductor may remain supported and still, the method is often unsuccessful in the field. Performing the cleaning steps successfully on an aerial platform such as a bucket truck is highly improbable due to difficultly in handling the individual conductive strands. The strands must be held in a suitable manner to brush them with sufficient force to effectively remove the oxide layer. Therefore, this method typically is not done in the field.

In addition, difficulties arise when the strands are re-layered into their original position. Compression connectors are designed with minimal space to receive the design standard of the outer diameter of the conductor. Consequently, if the strands are not re-layered to provide the original diameter of the conductor as manufactured, the conductor cannot be inserted into the compression connector designed therefore.

Additionally, the above method does not solve the problem of rapid formation of oxides. After the stranding is brushed and a large portion of the old oxide coating removed, new oxides form immediately on the clean surfaces exposed to oxygen. The newly formed oxides, formed on the surface of the aluminum strands, prevent the passage of current between the innermost strands of the conductor through each successive layer and the compression connector.

Another prior art cleaning method requires the use of an abrasive material such as a sand paper. The sand paper is wrapped about the periphery of each individual strand for abrading the oxide layer. However, the abrasive material will also wipe away the oil coating of the inhibitor designed to provide the oxygen barrier needed to prevent the re-growth of the oxide layer which the cleaner is attempting to remove.

Lastly, abrasive inhibitors are also used to enhance the electrical performance of connectors. During the compression process, a gritted inhibitor is forced hydraulically through interstitial spaces between the strands. The inhibitor abrades the oxide layer as it progresses. However, this method works well only on the outer layer. Rarely, does any significant amount of the gritted inhibitor find its way to the inner layer interstices. Thus, the current being carried by the inner layers of the conductor meets a high resistance interface. As a result, the outer layers have higher current densities and increase the temperature of the conductor, particularly at the connector interface.

While the aforementioned methods help to some degree, a continuing recurrence of connector failures in electrical grid infrastructures necessitates improvements to enhance the integrity and longevity of the electrical connectors.

Thus, a continuing need exists to provide improved compression connectors.

### SUMMARY OF THE INVENTION

Accordingly, it is a primary object to provide a stepped compression connector and a method of securing a cable having a stepped inner surface for the purpose of providing an electrically clean and intimate current path from all layers of conductor stranding to the tubular bore.

Another object of the invention is to provide a stepped compression connector assembly and method of securing a cable relatively simple to use in comparison to unlaying and relaying the conductor stranding for a thorough cleaning.

A further object of the invention is to improve performance by reducing the number of actual interfaces, thereby enhancing the integrity of the connection and providing assurance of a low resistance interface with each layer of conductor stranding.

A further object of the invention is the reduction of size. A shorter stepped compression connector will reduce extrusion and birdcaging of the conductor.

The foregoing objects are basically attained by providing a stepped compression connector for securing a multi-layered cable. The stepped compression connector includes a body having an exterior surface, a cable receiving open end, and a terminal connection end with an endwall. A generally tubular bore extends into the body from the cable receiving open end including an inner surface. At least one axial slot is disposed on the inner surface for facilitating compression of the body. At least two surface contours are positioned on the inner surface and have different diameters forming at least one step therebetween.

The foregoing objects are also attained by providing a wire splicing connector for splicing two multi-layered conductor cables. The wire splicing connector includes a body having an exterior surface and cable receiving open ends. A generally tubular bore extends into the body from the open ends and includes an inner surface and a cable splicing passageway. At least one slot is disposed on the inner surface for facilitating compression of the body. The cable splicing passageway is positioned intermediate a proximate and distal end portion of the body. The proximate and distal end portions each have at least two surface contours positioned on respective inner surfaces having different diameters forming at least one step therebetween.

The foregoing objects are further attained by providing a method of securing a multi-layered cable to a terminal comprising the steps of trimming the cable to expose at least one underlying layer. Cleaning the exposed at least one underlying layer and a generally tubular bore of a stepped compression connector to remove any oxide coating. Placing the stepped tubular bore over the at least one exposed underlying layer so that the at least one underlying layer is received within the outermost diametrical portion and the core layer is disposed within the innermost diametrical portion of the tubular bore.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

Referring now to the drawings which form a part of this original disclosure:

FIG. 1 is a perspective view in section of a stepped compression connector in accordance with the present invention.

FIG. 2 is a perspective view in section of the stepped compression connector of FIG. 1, having a cable disposed within the tubular bore.

FIG. 3 is a perspective view in section of a stepped compression connector in accordance with a second embodiment the present invention.

FIG. 4 is a perspective view in section of the stepped compression connector of FIG. 3, having a cable disposed within the tubular bore.

FIG. 5 is a perspective view in section of the stepped compression connector of FIG. 1 having an axial slot.

FIG. 6 is a perspective view in section of a stepped compression connector in accordance with a third embodiment of the present invention.

FIG. 7 is a perspective view of the stepped compression connector of FIG. 1, illustrating the stepped compression connector receiving a multi-layered cable and having a plurality of receiving apertures.

FIG. 8 is a perspective view of the stepped compression connector of FIG. 1, illustrating a crimping tool compressing the compression connector and multi-layered cable.

### DETAILED DESCRIPTION OF THE INVENTION

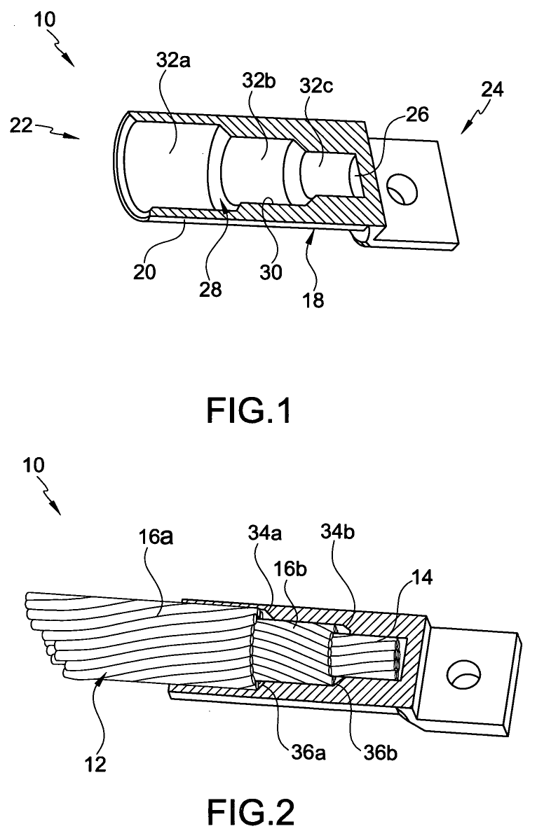

With reference to FIGS. 1-2, 5 and 7-8, a stepped compression connector 10 is for receiving a multi-layered conductor cable 12. The stepped compression connector includes a body 18 having an exterior surface 20, a cable receiving open end 22, and a terminal connection end 24 with an endwall 26. A generally tubular bore 28 extends into the body from the cable receiving open end 22 and includes an inner surface 30. Positioned on the inner surface 30 are surface contours 32a-c. The surface contours 32a-c are of different diameters and form steps 34a-b.

As best seen in FIGS. 1-2, stepped compression connector 10 is utilized to secure a multi-layered conductor cable 12. A typical composite multi-layered conductor cable 12 has a core layer 14 made of solid or stranded steel surrounded by outer layers 16a-b, made of aluminum. However, the assembly is capable of use with any metal or combination of metal cables including an all aluminum conductor. As illustrated in FIG. 8, composite cables have multiple layers of individual strands 17. Individual strands 17 are helically wound opposite to adjacent layers 14, 16a-b, thereby making each adjacent layer 14, 16a-b distinctive from one another.

Stepped compression connector 10 includes a substantially cylindrical body 18 having an exterior surface 20, a cable receiving open end 22, and a terminal connection end 24. Terminal connection end 24 includes an end wall 26. A generally tubular bore 28 extends into body 18 from cable receiving open end 22 and includes an inner surface 30.

Surface contours 32a-c are disposed on inner surface 30 for receiving multi-layered conductor cable 12. Tubular bore 28 is constructed of an axial length and diameter approximately equivalent to that of a corresponding layer of conductor cable 12. Bore 28 has a first diametrical portion at contour 32c approximately equal to the core layer 14 to which contact is made and a second diametrical portion at contours 32a-b which is approximately equal to the respective outer layers 16a-b of conductor cable 12 to which contact is made. If a greater plurality of outer layers other than layers 16a-b are desired or necessary, additional steps may be provided.

Steps 34a-b are formed between successive surface contours 32a-c. A partially tapered axial space 36a-b is positioned on each step 34a-b along inner surface 30 for permitting elongation of the multi-layered conductor cable 12. The tapered section extends inwardly towards the tubular bore 28. Axial spaces 36a-b ensure that successive steps are positioned a predetermined distance apart. Therefore, upon compression of stepped compression connector 10, axial spaces 36a-b permit expansion of multi-layered conductor cable 12 so steps 34a-b do not abut the ends of adjacent layers of stranding during extrusion. Thus, the axial spaces 36a-b prevent birdcaging.

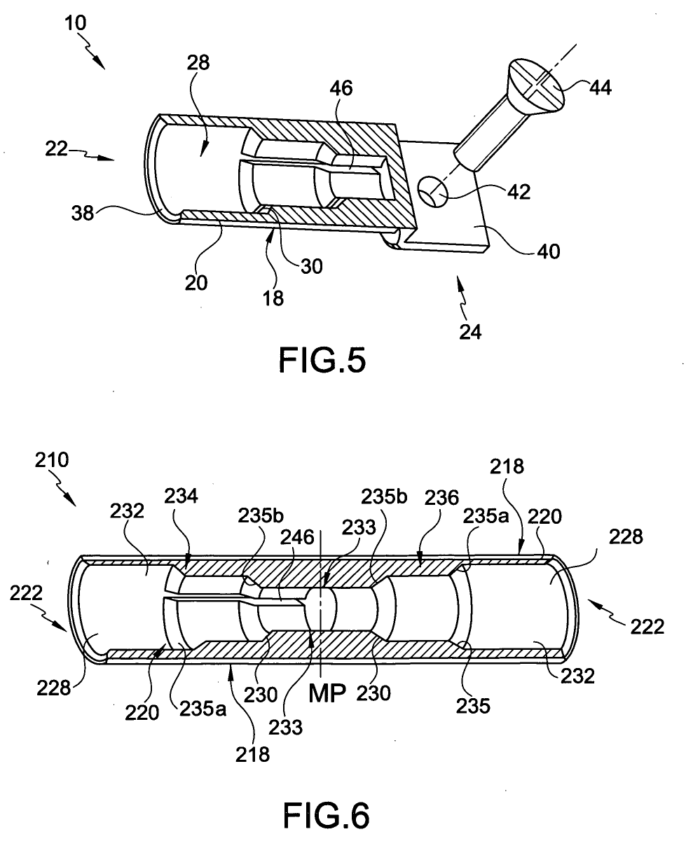

Turning to FIG. 5, cable receiving open end 22 may also include a chamfered edge 38 for facilitating insertion of the multi-layered conductor cable 12 into tubular bore 28. Chamfered edge slopes downwardly extending in a direction towards terminal connection end 24.

A substantially polygonal landing 40 extends from a terminal connection end 24 for fastening body 18 to a terminal (not shown). Preferably, landing is rectangularly shaped; however, any polygonal shape or combination of polygonal shapes with sufficient surface area is adequate. Landing 40 includes at least one aperture 42 for receiving a fastener 44. Fastener 44 can be any one of or combination of a bolt, coupling, dowel, universal joint, lug, rivet, screw, nut, wing nut, or pin adapted for use with aperture 42.

Inner surface 30 includes an axial slot 46 disposed thereon for facilitating compression of said body 18. Although not illustrated, a plurality of axial slots may be used. Axial slot 46 is provided for minimizing the compressive forces necessary for deformation during compression installation. Each slot 46 may be axially, longitudinally, transversely, or helically positioned on the inner surface 30.

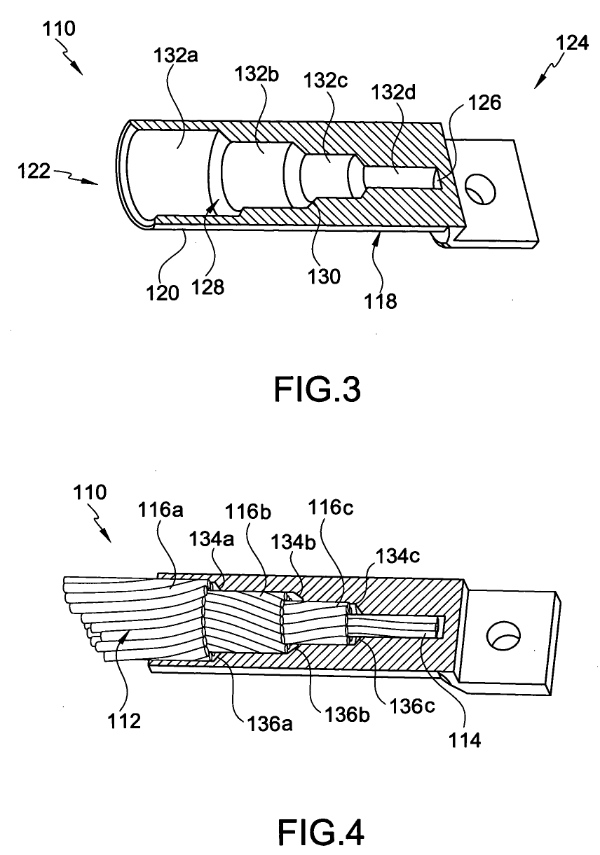

A stepped compression connector 110 according to a second embodiment of the invention is illustrated in FIGS. 3-4. Stepped compression connector 110 includes a substantially cylindrical body 118 having an exterior surface 120, a cable receiving open end 122, and a terminal connection end 124. Terminal connection end 24 includes an end wall 126. A generally tubular bore 128 extends into body 118 from cable receiving open end 122 and includes an inner surface 130.

Surface contours 132a-d are disposed on inner surface 130 for receiving multi-layered conductor cable 12. Surface contour 132d may be surfaced with carbide grit or some other surface treatment to enhance the gripping strength of the connector 110. Tubular bore 128 is constructed of an axial length and diameter approximately equivalent to that of a corresponding layer of conductor cable 12. Bore 128 has a first diametrical portion at contour 132d approximately equal to the core layer 14 to which contact is made and a second diametrical portion at a contour 132a-c which is approximately equal to the respective outer layers 16a-b of conductor cable 12 to which contact is made. Steps 134a-c and tapered axial spaces 136a-c, corresponding to the steps 34a-b and axial spaces 36a-b of the first embodiment, are also provided in the second embodiment.

A wire splicing connector 210 according to a third embodiment of the invention is illustrated in FIG. 6. Similar to the stepped compression connector 10, wire splicing connector 210 includes a body 218 having an exterior surface 220 and cable receiving open ends 222. A generally tubular bore 228 extends into body 218 from cable receiving open ends 222 and includes an inner surface 230.

Wire splicing connector 210 includes a cable splicing passageways 232 for receiving ends of two mutli-layered conductor cables (not shown). The cable splicing passageways 232 are positioned intermediate proximate end portion 234 and distal end portion 236 of body 218. The proximate portion is defined by approximately half the axial length of body 218 and distal end portion is defined by approximately the other half the axial length of body 218. Body 218 is separated into two portions 234, 236, with the midpoint 233 dividing cable splicing passageways 232.

Surface contours 232 are disposed on inner surface 230, disposed in both proximate 234 and distal end 236 portions. Each surface contour in each end portion 234, 236, has a different diameter from the other, forming steps 235a-b between each surface contour 232 as in the previously disclosed embodiments. Lastly, wire splicing connector 210 also includes an axial slot 246 disposed on inner surface 230 for facilitating compression of body 218.

Prior to use, tubular bores 28, 128, 228 should be brushed and prepared to remove oxides and inhibit their reformation. Additionally, tubular bores 28, 128, and 228 may also be provided with any number of textured surfaces known in the art for disrupting oxide formation and simultaneously facilitating gripping of the cable.

Stepped compression connectors 10, 110, 210 are generally manufactured by one of impact extrusion or casting. Body 18, 118, 218 can be made from any conductive metal or metal alloy (e.g. copper, aluminum, nickel, etc.) Preferably, body 18, 118, 218 is substantially cylindrical in shape. However, body 18, 118, 218 may be any polygonal shape or combination of polygonal shapes.

### Operation

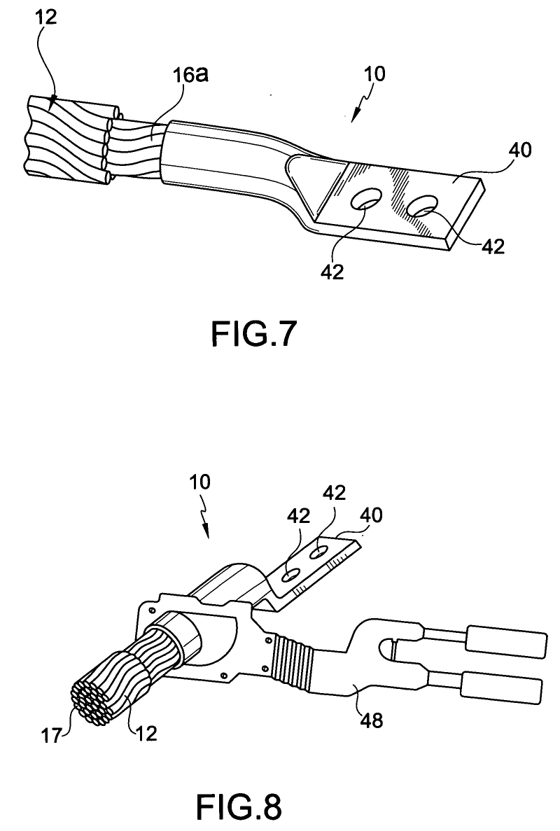

As best seen in FIGS. 7-8, stepped compression connector 10 is utilized for securing multi-layered conductor cable 12 to an electrical terminal (not shown).

The first step required to utilize the stepped compression insert 10 is to trim multi-layered conductor 12 to expose steel core 14 (or underlying strand of aluminum if all aluminum cable) and at least one outer aluminum layer 16a-b. Trimming is necessary in order to expose steel core layer 14 by paring back stranding 17. Tools, known in the art, are made for this purpose. The tools operate in the same fashion as a pipe or tube cutter.

The tools have a specially designed bushing guide that fastens to multi-layered conductor cable 12, serving to maintain the positional alignment of a rotary cutting wheel that circumscribes multi-layered conductor cable 12 as it is rotated about its periphery and is pressed deeper with successive rotations. The tool eventually cuts through first outer aluminum layer 16b and progresses deeper through successive layers until all of outer aluminum layers 16a are severed, thus exposing steel core layer 14. Each aluminum layer 16a is pared back exposing an underlying layer for cleaning.

The next step is to clean outer aluminum layers 16a-b and tubular bore 28 with an oxide inhibitor. Exposed outer aluminum layers 16a-b should be brushed prior to installation of body 18. Steel core layer 14 can be coated with a protective layer such as galvanizing to protect it from corrosion. Additionally, tubular bore 28 should be brushed and prepared to remove oxides and inhibit their reformation. Brushing serves to remove visible dirt and grime, while removing a heavy portion of the oxide layer. A liberal amount of inhibitor should then be applied to the outer aluminum layers 16a-b, and the tubular bore 28. The grease compound serves to protect the immediate surface and inhibit oxygen from contacting it, thereby inhibiting the oxide layer growth.

The inhibitor used contains grit, which serves as an abrasive agent. The grit bearing inhibitor is forced through layers 16a-b of strands 17 when the body 18 is compressed. The grit abrades the surface of strands 17 and tubular bore 28 cleaning out the oxide layer as it moves. Thus, clean metal to metal contact is made between tubular bore 28 and multi-layered conductor cable 12.

The body 18 is then placed over each exposed layer 14, 16a-b so that the steel core layer 14 and at least one outer aluminum layer 16a-b is positioned within tubular bore 28. A crimping tool 48 (FIG. 8) is then utilized to laterally compress the body 18 and secure the cable 12 within tubular bore 28 resulting in a crimped section. For example, this crimped section could be elliptical or polygonal in shape. The crimping is continued to an end of body 18, thus securing the multi-layered conductor cable 12 with stepped compression connector 10.

After crimping, body 18, specifically landing 40 and aperture 42, are positioned adjacent to the electrical terminal. Fastener 44 or suitable fastening means is used to secure the body 18 to the terminal. Stepped compression connector 110 would be utilized in the same fashion.

The wire splicing connector 210 of FIG. 6 would be used in the same fashion, except, the two multi-layered conductor cables 12 would be inserted from both cable receiving open ends 222. The two multi-layered conductor cables 12 would be inserted until the ends the multi-layered conductor cables 12 were positioned within the cable splicing passageways 232. A crimping tool 48 would then be utilized for laterally compressing the body 218 and securing the cable 12 within tubular bore 228 resulting in a crimped section. For example, this crimped section could be elliptical or polygonal in shape. The crimping is continued over the entire body 218, thus completing the method for joining the multi-layered conductor cables 12 within wire splicing connector 210.

While various embodiments have been chosen to illustrate the invention, it will be understood by those skilled in the art that various changes and modifications can be made therein without departing from the scope of the invention as defined in the appended claims.

1-22. (canceled)

23. An electrically conductive assembly, comprising:
a conductor having at least first and second coaxial and conductive layers, each of said layers comprising a plurality of individual conductive strands, said first layer being located within said second layer and extending axially beyond said second layer;
a compression connector coupled to one axial end of said conductor, said compression connector having a body, an exterior surface, a cable receiving open end, and a terminal connection end with an end wall; and
a generally tubular bore extending into said body from said open end including an inner surface, said inner surface having at least first and second surface contours with different diameters and being axially spaced from one another, said first surface contour having a smaller diameter than said second surface contour and being spaced a greater distance from said open end than said second surface contour, said individual conductive strands of said first and second layers being intimately engaged with said first and second surface contours, respectively.

24. An electrically conductive assembly according to claim 23 wherein
at least one axial slot is disposed on said inner surface for facilitating compression of said body.

25. An electrically conductive assembly according to claim 23 wherein
said open end being chamfered for facilitating insertion of a cable into said tubular bore.

26. An electrically conductive assembly according to claim 23 wherein
said terminal connection end includes a substantially polygonal landing extending therefrom for fastening said body to a terminal.

27. An electrically conductive assembly according to claim 26 wherein
said landing includes at least one aperture for receiving a fastener.

28. An electrically conductive assembly according to claim 23 wherein
one of said first and second surface contours includes a partially tapered axial space for permitting elongation and extrusion of said plurality of individual conductive strands.

29. An electrically conductive assembly according to claim 23 wherein
said body is manufactured by one of impact extrusion or casting.

30. An electrically conductive assembly according to claim 23 wherein
said body includes metal or a metal alloy.

31. A wire splicing connector for connecting two multi-layered conductor cables, comprising:
a conductor having at least first and second coaxial and conductive layers, each of said layers comprising a plurality of individual conductive strands, said first layer being located within said second layer and extending axially beyond said second layer;
a wire splicing connector coupled to one axial end of said conductor, said wire splicing connector having a body, an exterior surface, and first and second cable receiving open ends; and
a generally tubular bore extending into said body from said open ends including an inner surface, said inner surface having at least first and second contours with different diameters and being axially spaced from one another, said first surface contour having a smaller diameter than said second surface contour and being spaced a greater distance from said first open end than said second surface contour, said individual conductive strands of said first and second layers being intimately engaged with said first and second surface contours, respectively.

32. A wire splicing connector for connecting two multi-layered conductor cables according to claim 31 wherein
one of said first and second surface contours includes a partially tapered axial space for permitting elongation and extrusion of said plurality of individual conductive strands.

33. A wire splicing connector for connecting two multi-layered conductor cables according to claim 31 wherein
said open ends being chamfered for facilitating insertion of a cable into said tubular bore.

34. A method of securing a conductor to a terminal, comprising the steps of:
providing a conductor having at least first and second coaxial and conductive layers, each of the layers comprising a plurality of individual conductive strands, the first layer being located within the second layer and extending axially beyond the second layer;
providing a compression connector coupled to one axial end of the conductor, the compression connector having a body, an exterior surface, and a cable receiving open end;
paring back the strands of the second layer exposing the strands of the first layer;
cleaning the strands of the first layer and a generally tubular bore in the compression connector to remove any oxide coating, the tubular bore extending into the body from the open end including an inner surface, having at least first and second surface contours with different diameters and being axially spaced from one another, the first surface contour having a smaller diameter than the second surface contour and being spaced a greater distance from the open end than the second surface contour; and
placing the tubular bore over the cable so that the first layer is received within the first surface contour and the second layer of the cable is disposed within the second surface contour of the tubular bore with the individual conductive strands of the first and second layers being intimately engaged with the first and second surface contours, respectively.

35. A method of securing a conductor to a terminal according to claim 34, further comprising the steps of:
laterally compressing a body of the compression connector for securing the cable within the tubular bore.

36. A method of securing a conductor to a terminal according to claim 34, further comprising the steps of:
applying an abrasive to the innermost surface contour of the tubular bore for facilitating the gripping of the cable.
